(19) United States
(12) Patent Application Publication
(10) Pub. No.: US 2015/0346395 A1
(43) Pub. Date: Dec. 3, 2015

(54) LENS STRUCTURE

(71) Applicant: Au Optronics Corporation, Hsinchu (TW)

(72) Inventors: I-Wei Chen, Hualien County (TW); Sheng-Ju Ho, Hsinchu City (TW)

(21) Appl. No.: 14/640,027

(22) Filed: Mar. 6, 2015

(30) Foreign Application Priority Data
May 28, 2014 (TW) 103118659

(51) Int. Cl. G02B 3/08; G02B 27/22

(52) U.S. Cl. CPC G02B 3/08; G02B 27/22

(57) ABSTRACT

A lens structure includes a plurality of lens units. Each of the lens units includes upper and lower substrates, an electrode film, a center electrode, an edge electrode, and at least one set of side electrodes. The electrode film on the upper substrate has a voltage Vtop. The center electrode on the lower substrate has a voltage Vc. The edge electrode on the lower substrate and on two sides of the center electrode has a voltage Ve. Each set of side electrodes is located on the lower substrate and between the center electrode and the edge electrode, and each set of side electrodes includes a main electrode and first and second auxiliary electrodes located on two sides of the main electrode. Voltages of the main electrode, the first auxiliary electrode, and the second auxiliary electrode are Vf, Vm, and Vfm, respectively, Vf>Vc>Ve, Vf>Vtop>Ve, and Vf>Vm>Ve.

### CROSS-REFERENCE TO RELATED APPLICATION

This application claims the priority benefit of Taiwan application serial no. 103118659, filed on May 28, 2014. The entirety of the above-mentioned patent application is hereby incorporated by reference herein and made a part of this specification.

### FIELD OF THE INVENTION

The invention relates to an optical structure. More particularly, the invention relates to a lens structure.

### DESCRIPTION OF RELATED ART

In recent years, continuous advancement of display technologies results in increasing demands on display quality of display devices, such as image resolution, color saturation, and so on. To satisfy users' requirements for watching real images, displays that are not only characterized by high image resolution and satisfactory color saturation but also capable of displaying stereo images have been developed. A stereo display constituted by a liquid crystal lens, which is alternatively referred to as a gradient-index lens (a GRIN lens), is one of the extensively applied stereo display devices. Due to the facts that the tilting directions of liquid crystal molecules in a conventional stereo display device constituted by the liquid crystal lens are inconsistent, the disclination lines may be easily generated, which further leads to issues of crosstalk, mura, and poor display quality.

### SUMMARY OF THE INVENTION

The invention is directed to a lens structure. If a display device is equipped with such a lens structure, no disclination line is formed, and the display quality of a stereo display device having such lens structure can be improved.

In an embodiment of the invention, a lens structure that includes a plurality of lens units is provided. Each of the lens units includes an upper substrate, a lower substrate, an anisotropic birefringence medium, an electrode film, a center electrode, an edge electrode, and at least one set of side electrodes. The upper substrate and the lower substrate are arranged opposite to each other. The anisotropic birefringence medium is located between the upper substrate and the lower substrate. The electrode film is located on the upper substrate, and a voltage of the electrode film is Vtop. The center electrode is located on the lower substrate, and a voltage of the center electrode is Vc. An edge electrode is located on the lower substrate and on two sides of the center electrode, and a voltage of the edge electrode is Ve. At least one set of side electrodes is located on the lower substrate and between the center electrode and the edge electrode. Each of the at least one set of side electrodes includes a main electrode, a first auxiliary electrode, and a second auxiliary electrode, and the first and second auxiliary electrodes are located on two sides of the main electrode. A voltage of the main electrode is Vf, a voltage of the first auxiliary electrode is Vm, and a voltage of the second auxiliary electrode is Vfm. Here, Vf>Vc>Ve, Vf>Vtop>Ve, and Vf>Vm>Ve. An electric field distribution is generated between the upper substrate and the lower substrate; due to the electric field distribution, the anisotropic birefringence medium constitutes a Fresnel lens.

In light of the above, the tilting directions of the liquid crystal molecules in the lens structure described herein are appropriate. Hence, if the lens structure described herein is applied in a stereo display device, the disclination line may not be generated, issues of crosstalk and mura may not arise, and the display quality of the stereo display device may be improved.

Several exemplary embodiments accompanied with figures are described in detail below to further describe the invention in details.

### BRIEF DESCRIPTION OF THE DRAWINGS

FIG. 1 is a schematic cross-sectional view illustrating a stereo display device according to an embodiment of the invention.

FIG. 2 is a schematic cross-sectional view illustrating one of the lens units in a lens structure according to a first embodiment of the invention.

FIG. 3A to FIG. 3C schematically illustrate a voltage of each electrode in the lens unit shown in FIG. 2 while the voltage is applied to the lens unit according to three embodiments of the invention.

FIG. 4 is a schematic cross-sectional view illustrating one of the lens units in a lens structure according to a second embodiment of the invention.

FIG. 5A to FIG. 5C schematically illustrate a voltage of each electrode in the lens unit shown in FIG. 4 while the voltage is applied to the lens unit according to three embodiments of the invention.

### DETAILED DESCRIPTION OF DISCLOSED EMBODIMENTS

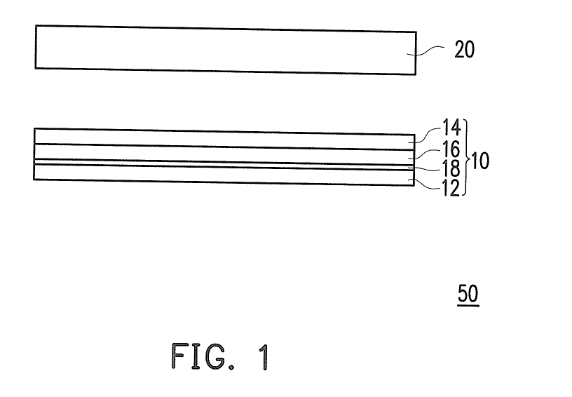

FIG. 1 is a schematic cross-sectional view illustrating a stereo display device according to an embodiment of the invention. With reference to FIG. 1, the stereo display device 50 may include a display panel 10 and a lens structure 20. According to the present embodiment, the stereo display device 50 is, for instance, constituted by a liquid crystal lens.

The display panel 10 includes a pair of substrates 12 and 14 and a display medium 16. The display medium 16 is sandwiched between the substrate 12 and the substrate 14. The pixel array 18 is located on the substrate 12. The display panel 10 may be any device capable of display images; based on self-luminescent and non-self-luminescent materials in the display medium 16 of the display panel 10, the display panel 10 may be characterized into a self-luminescent display panel and a non-self-luminescent display panel. The self-luminescent display panel includes an organic electroluminescent display panel, a plasma display panel, a field emissive display panel, or any other type of self-luminescent display panel; the non-self-luminescent display panel includes a liquid crystal display (LCD) panel, such as a horizontal electric-field-driven display panel, a vertical electric-field-driven display panel, a blue-phase LCD panel, a fringe electric-field-driven display panel, or any other suitable display panel, an electrophoretic display panel, an electrowetting display panel, an electro-dust display panel, or any other suitable display panel. Here, if a non-self-luminescent material serves as the display medium 16 of the display panel 10, the stereo display device 50 may selectively include a light source module to provide a light source required for image display.

In some embodiments of the invention, the display panel 10 further has a plurality of pixel units (not shown), each of which includes a plurality of sub-pixel units. The sub-pixel units include red sub-pixel units, green sub-pixel units, and blue sub-pixel units, for instance. These sub-pixel units are arranged along a specific direction, so as to constitute the pixel array 18. Therefore, the pixel array 18 has plural columns and rows. In general, each of the sub-pixel units in the pixel array 18 includes a data line, a scan line, an active device, a pixel electrode, and so forth. Besides, each sub-pixel unit may further include color filter patterns located in the pixel array 18 or on the substrate 14. Since the components of the sub-pixel units are known to people having ordinary skill in the pertinent art, no other detailed explanations are further provided hereinafter.

The lens structure 20 is located on one side of the display panel 10. According to the present embodiment, the display surface of the display panel 10 faces the lens structure 20, i.e., the lens structure 20 is located above the display panel 10. Thereby, the lens structure 20 effectuates the display panel 10 to achieve stereo image display effects. In particular, said configuration allows the light emitted from the display panel 10 to be refracted through the lens structure 20, so as to form the left light path projected to the left eye and the right light path projected to the right eye and further enable human eyes to see the stereo images. Detailed descriptions of the lens structure 20 will be provided below.

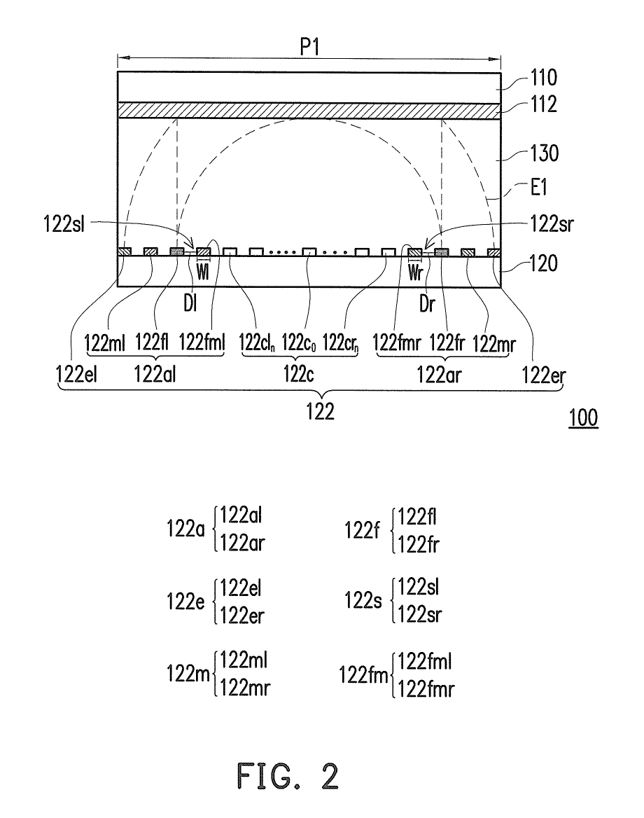

FIG. 2 is a schematic cross-sectional view illustrating one of the lens units in the lens structure 20 according to a first embodiment of the invention. The lens structure 20 has a plurality of lens units 100. For illustrative purposes, FIG. 2 merely shows one lens unit 100 in the lens structure 20 depicted in FIG. 1, and people skilled in the art should be able to understand that the lens structure 20 depicted in FIG. 1 is constituted by plural lens units 100 (shown in FIG. 2) arranged in an array.

With reference to FIG. 2, each lens unit 100 of the lens structure 20 includes an upper substrate 110, a lower substrate 120, an anisotropic birefringence medium 130, an electrode film 112, and an electrode layer 122, and a pitch of each lens unit 100 is P1.

The upper substrate 110 and the lower substrate 120 are arranged opposite to each other. Here, the upper substrate 110 and the lower substrate 120 are made of glass, quartz, an organic polymer, metal, or any other appropriate material.

The anisotropic birefringence medium 130 is located between the upper substrate 110 and the lower substrate 120. Here, the anisotropic birefringence medium 130 includes a plurality of liquid crystal molecules (not shown), for instance; the liquid crystal molecules are optically anisotropic in case of the presence of the electric field and are optically isotropic under a non-electric-field environment.

The electrode film 112 is located on the upper substrate 110 and between the upper substrate 110 and the anisotropic birefringence medium 130. A material of the electrode film 112 is, for instance, indium tin oxide (ITO), indium zinc oxide (IZO), aluminum zinc oxide (AZO), gallium zinc oxide (GZO), indium gallium oxide (IGO), indium gallium zinc oxide (IGZO), any other suitable conductive material, or any other appropriate light-transmissive conductive material.

The electrode layer 122 is located on the lower substrate 120 and between the lower substrate 120 and the anisotropic birefringence medium 130. The electrode layer 122 includes a center electrode 122c, an edge electrode 122e, and at least one set of side electrodes 122a. A material of the electrode layer 122 is, for instance, ITO, IZO, AZO, GZO, IGO, IGZO, any other suitable conductive material, or any other appropriate light-transmissive conductive material.

The center electrode 122c is located on the lower substrate 120 and at the central location of the electrode layer 122. According to the present embodiment, the center electrode 122c includes a center sub-electrode 122c₀, N right sub-electrodes 122cr₁ to 122crₙ, and N left sub-electrodes 122cl₁ to 122clₙ, and the N right sub-electrodes 122cr₁ to 122crₙ and the N left sub-electrodes 122cl₁ to 122clₙ are located on two sides of the center sub-electrode 122c₀. Here, the pitch between every two adjacent sub-electrodes may stay unchanged. However, the invention is not limited thereto; in other embodiments of the invention, the configuration, the number, and the pattern of the center electrode 122c may be different from those provided herein.

The edge electrode 122e is located on the lower substrate 120 and on two sides of the center electrode 122c. That is, the edge electrode 122e is located on the edge of the electrode layer 122. Particularly, the edge electrode 122e may include a right edge electrode 122er and a left edge electrode 122el, the right edge electrode 122er and the left edge electrode 122el are correspondingly arranged on two edges of the center electrode 122c.

At least one set of side electrodes 122a is located on the lower substrate 120 and between the center electrode 122c and the edge electrode 122e. Each of the at least one set of side electrodes 122a includes a main electrode 122f, a first auxiliary electrode 122m, and a second auxiliary electrode 122fm. In each set of side electrodes 122a, the main electrode 122f is located between the first auxiliary electrode 122m and the second auxiliary electrode 122fm, the second auxiliary electrode 122fm is located between the first auxiliary electrode 122m and the center electrode 122c, and the first auxiliary electrode 122m is located between the main electrode 122f and the edge electrode 122e.

In the present embodiment, the at least one set of side electrodes 122a may include at least one set of right side electrodes 122ar and at least one set of left side electrodes 122al, the at least one set of right side electrodes 122ar is arranged between the center electrode 122c and the right edge electrode 122er, and the at least one set of left side electrodes 122al is arranged between the center electrode 122c and the left edge electrode 122el. Each set of right side electrodes 122ar includes a right main electrode 122fr, a first right auxiliary electrode 122mr, and a second right auxiliary electrode 122fmr, and the first right auxiliary electrode 122mr and the second right auxiliary electrode 122fmr are located on two sides of the right main electrode 122fr. Each set of left side electrodes 122al includes a left main electrode 122fl, a first left auxiliary electrode 122ml, and a second left auxiliary electrode 122fml, and the first left auxiliary electrode 122ml and the second left auxiliary electrode 122fml are located on two sides of the left main electrode 122fl.

In the present embodiment, the second auxiliary electrode 122fm of each set of side electrodes 122a has a width W, a pitch of each of the lens units 100 is P1, and W/P1≦5%. To be specific, the second right auxiliary electrode 122fmr of the right side electrode 122a has the width Wr, the second left auxiliary electrode 122fml of the left side electrode 122a has the width W1, the width Wr is smaller than the pitch P1, and the width W1 is smaller than a the pitch P1, and Wr/P1≦5%, and W1/P1≦5%.

The right edge electrode 122er and the left edge electrode 122el are mirror-symmetrical to each other, and the at least one set of right side electrodes 122ar and the at least one set of left side electrodes 122al are mirror-symmetrical to each other.

According to the present embodiment, a slit 122s may be formed between the main electrode 122f and the second auxiliary electrode 122fm. In particular, a right slit 122sr is between the right main electrode 122fr and the second right auxiliary electrode 122fmr, and a left slit 122sl is between the left main electrode 122fl and the second left auxiliary electrode 122fml. A width of the right slit 122sr is Dr, a width of the left slit 122sl is D1, the width Dr is smaller than the pitch P1 of each lens unit 100, and the width D1 is smaller than a the pitch P1, and Dr/P1≦5%, and D1/P1≦5%.

According to the present embodiment, the electrode film 112, the center electrode 122c, the edge electrode 122e, and at least one set of side electrodes 122a constitute an electric field distribution E1 between the upper substrate 110 and the lower substrate 120, and the electric field distribution E1 allows the anisotropic birefringence medium 130 to constitute a Fresnel lens. To be specific, the electrode film 112, the center electrode 122c, the right edge electrode 122er, the left edge electrode 122el, at least one set of right side electrodes 122ar, and at least one set of left side electrodes 122al constitute the electric field distribution E1 between the upper substrate 110 and the lower substrate 120, and the electric field distribution E1 allows the anisotropic birefringence medium 130 to constitute the Fresnel lens. The right edge electrode 122er and the left edge electrode 122el are placed at the location of the lens pitch of the Fresnel lens. It should be mentioned that the display panel 100 described in the present embodiment is merely equipped with one set of right side electrodes 122ar and one set of left side electrodes 122al, and thus the anisotropic birefringence medium 130 described in the present embodiment constitutes a one-level Fresnel lens, for instance.

According to an embodiment of the invention, the anisotropic birefringence medium 130 constitute an equivalent Fresnel lens through the design of the electrode pattern and voltages of the electrode film 112 and the electrode layer 122 as well as through the resultant electric field distribution E1, and the thickness of the Fresnel lens is smaller than that of the conventional lens (i.e., a cell gap or a liquid crystal cell gap of the Fresnel lens is smaller that that of the conventional lens), the volume of the stereo display device can be reduced, and the costs of materials of the stereo display device can be lowered down. The voltage designs of various electrodes provided in different embodiments of the invention will be elaborated in detail below.

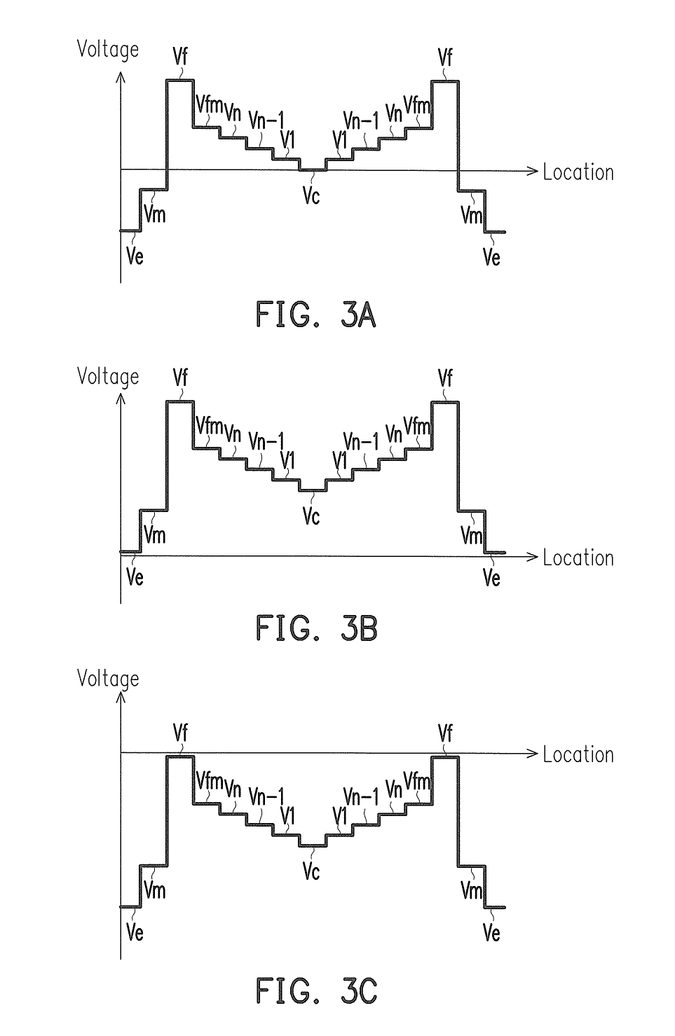

FIG. 3A to FIG. 3C schematically illustrate a voltage of each electrode in the lens unit shown in FIG. 2 while the voltage is applied to the lens unit according to three embodiments of the invention. In FIG. 3A to FIG. 3C, the voltage levels of the center electrode are limited to four (from the center of the lens unit to the two sides of the lens unit) for illustrative purposes; however, people skilled in the pertinent art should be aware that the voltage levels of the center electrode are not limited to those shown in the drawings because the center electrode described herein may have plural center sub-electrodes.

With reference to FIG. 3A which shows that a driver voltage is applied to the lens unit 100 depicted in FIG. 2. Here, the driver voltage applied to the electrodes of the lens unit 100 includes positive and negative voltages. Here, the driver voltage applied to the electrodes is, for instance, a direct-current (DC) driver voltage. Particularly, a voltage of the center electrode of the electrode layer 122 is Vc, the voltage of the edge electrode is Ve, the voltage of the main electrode 122f is Vf, the voltage of the first auxiliary electrode 122m is Vm, the voltage of the second auxiliary electrode 122fm is Vfm, and the voltage of the electrode film 112 is Vtop. Here, Vf>Vc>Ve, Vf>Vtop>Ve, and Vf>Vm>Ve.

A threshold voltage of the anisotropic birefringence medium 130 is Vt (not shown), for instance. An absolute value of the threshold voltage Vt of the anisotropic birefringence medium 130 is greater than the absolute value of the difference between the voltage Vtop of the electrode film 112 and the voltage Vc of the center electrode. Namely, |Vt|>|Vtop−Vc|.

Besides, as to the relationship among the voltages of the main electrode 122f, the second auxiliary electrode 122fm, and the edge electrode 122e, the voltage value obtained by subtracting the voltage Vfm of the second auxiliary electrode 122fm from the voltage Vf of the main electrode 122f is grater than ⅙ of the voltage value obtained by subtracting the voltage Ve of the edge electrode 122e from the voltage Vf of the main electrode 122f. That is, in the present embodiment, Vf−Vfm>(Vf−Ve)/6.

Moreover, if the center electrode 122c includes the center sub-electrode 122c₀, the N right sub-electrodes 122cr₁ to 122crₙ, and the N left sub-electrodes 122cl₁ to 122clₙ, the N right sub-electrodes 122cr₁ to 122crₙ and the N left sub-electrodes 122cl₁ to 122clₙ are located on two sides of the center sub-electrode 122c₀, the voltage of the center sub-electrode 122c₀ is Vc, and a voltage of the N^{th} right sub-electrode and a voltage of the N^{th} left sub-electrode are Vn, respectively, the voltages of the sub-electrodes are increased from the voltages of the center sub-electrode 122c₀ to the voltages of the sub-electrodes on two sides, i.e., Vc<V1<Vn−1<Vn. In addition, according to the present embodiment, the voltage Vf of the main electrode 122f is greater than the voltage V in of the second auxiliary electrode 122fm, and the voltage Vfm of the second auxiliary electrode 122fm is greater than the voltage Vn of the right or left sub-electrode; therefore, in the present embodiment, Vc<Vn<Vfm<Vf.

With reference to FIG. 3B, the embodiment shown in FIG. 3B is similar to that shown in FIG. 3A, while the difference therebetween lines in that the driver voltage applied to the electrodes of the lens unit 100 is a positive voltage. Here, the driver voltage applied to the electrodes is, for instance, an alternating-current (AC) driver voltage.

In the embodiment shown in FIG. 3B, each voltage is a positive voltage and is greater than zero, and the relationship among the voltages is the same as that provided in the embodiment shown in FIG. 3A. For instance, the voltage of the main electrode 122f is Vf, the voltage of the first auxiliary electrode 122m is Vm, the voltage of the second auxiliary electrode 122fm is Vfm, and the voltage of the electrode film 112 is Vtop. Here, Vf>Vc>Ve, Vf>Vtop>Ve, and Vf>Vm>Ve.

With reference to FIG. 3C, the embodiment shown in FIG. 3C is similar to that shown in FIG. 3A, while the difference therebetween lines in that the driver voltage applied to the electrodes of the lens unit 100 is a negative voltage. Here, the driver voltage applied to the electrodes is, for instance, an AC driver voltage.

In the embodiment shown in FIG. 3C, each voltage is a negative voltage and is less than zero, and the relationship among the voltages is the same as that provided in the embodiment shown in FIG. 3A. For instance, Vf>Vc>Ve, Vf>Vtop>Ve, and Vf>Vm>Ve.

In view of the above, the voltage conditions of each electrode in the electrode layer 122 are set to be desirable, such that the resultant electric field distribution E1 has the desirable shape and effects of the Fresnel lens; thereby, the liquid crystal molecules in the lens structure may have favorable tilting directions. More specifically, the voltage Vfm of the second auxiliary electrode 122fm and the voltage Vtop of the electrode film 112 may be adopted to modify the shape of the oblique attack of the Fresnel lens, so as to effectively prevent the mura phenomenon. What is more, the electrode film 112, the right slits 122sr, and the left slits 122sl may be adopted to make the vertical line of the Fresnel lens more in the perpendicular direction. As a result, the design of the electrode patterns and voltages provided in an embodiment of the invention can prevent the occurrence of disclination lines, crosstalk, and mura, thus improving the display quality of a stereo display device.

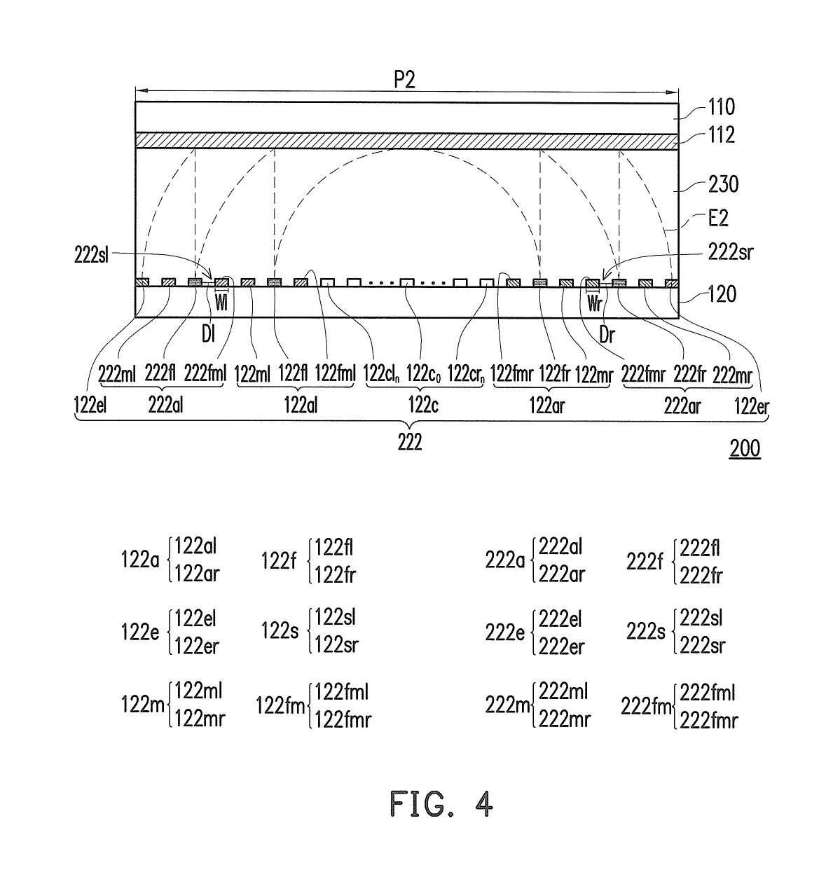

FIG. 4 is a schematic cross-sectional view illustrating one of the lens units 200 in the lens structure 20 according to a second embodiment of the invention. The second embodiment depicted in FIG. 4 is similar to the first embodiment depicted in FIG. 2; therefore, the identical or similar devices in these embodiments are represented by the identical or similar reference numbers and will not be further explained. The difference between the embodiment depicted in FIG. 4 and the embodiment depicted in FIG. 2 lies in that the anisotropic birefringence medium 230 described in the present embodiment constitutes a two-level Fresnel lens. Particularly, in the embodiment shown in FIG. 2 (in case of the one-level Fresnel lens), the electrode layer 122 has one set of side electrodes 122a; in the embodiment shown in FIG. 4 (in case of the two-level Fresnel lens), the electrode layer 222 has two sets of side electrodes 122a and 222a. That is, as long as the electrode layer has N sets of side electrodes, the anisotropic birefringence medium 230 described in the present embodiment constitutes an N-level Fresnel lens, such that the two-level Fresnel lens or multi-level Fresnel lenses all fall within the scope of the invention.

According to the present embodiment, the other set of side electrodes 222a is located on the lower substrate 120 and between the edge electrode 122e and one set of side electrodes 122a. Each set of side electrodes 222a may include at least one set of right side electrodes 222ar and at least one set of left side electrodes 222al, the set of right side electrodes 222ar is arranged between the center electrode 122c and the right edge electrode 122er, and the set of left side electrodes 222al is arranged between the center electrode 122c and the left edge electrode 122el. Each set of right side electrodes 222ar includes a right main electrode 222fr, a first right auxiliary electrode 222mr, and a second right auxiliary electrode 222fmr, and the first right auxiliary electrode 222mr and the second right auxiliary electrode 222fmr are located on two sides of the right main electrode 222fr. Each set of left side electrodes 222al includes a left main electrode 222fl, a first left auxiliary electrode 222ml, and a second left auxiliary electrode 222fml, and the first left auxiliary electrode 222ml and the second left auxiliary electrode 222fml are located on two sides of the left main electrode 222fl.

According to the present embodiment, the second auxiliary electrode 222fr of each set of side electrodes 222a has a width W. If the pitch of each lens unit 200 is P2, W/P2≦5%. To be specific, the second right auxiliary electrode 222fmr of the right side electrode 222ar has the width Wr, the second left auxiliary electrode 222fml of the left side electrode 222al has the width W1; if the pitch of each lens unit 200 is P2, Wr/P2≦5%, and W1/P2≦5%. A slit 222s may be formed between the main electrode 222f and the second auxiliary electrode 222fm. In particular, a right slit 222sr is between the right main electrode 222fr and the second right auxiliary electrode 222fmr, and a left slit 222sl is between the left main electrode 222fl and the second left auxiliary electrode 222fml. The width of the right slit 222sr is Dr, and the width of the left slit 222sl is D1. If the pitch of each lens unit 200 is P2, Dr/P2≦5%, and D₁/P2≦5%.

According to the present embodiment, the center electrode 122c, the edge electrode 122e, and one set of side electrodes 122a, and the other set of side electrodes 222a constitute an electric field distribution E2 between the upper substrate 110 and the lower substrate 120, and the electric field distribution E2 allows the anisotropic birefringence medium 230 to constitute a two-level Fresnel lens.

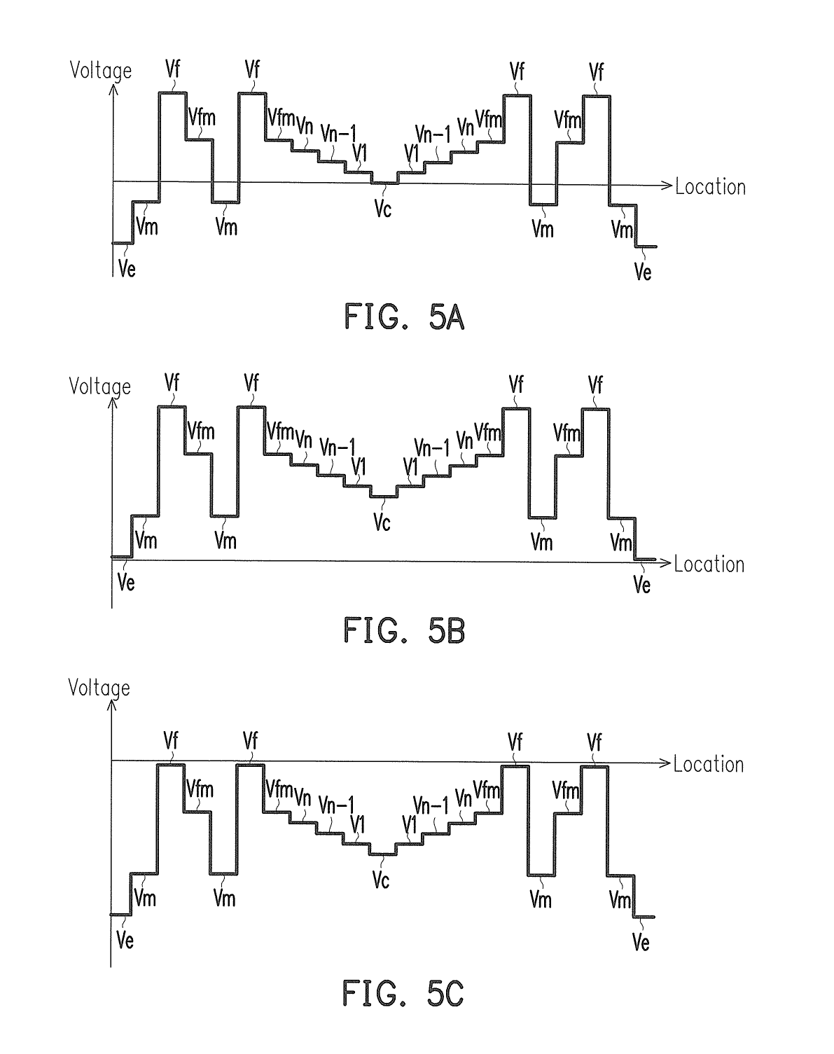

FIG. 5A to FIG. 5C schematically illustrate a voltage of each electrode in the lens unit shown in FIG. 4 while the voltage is applied to the lens unit according to three embodiments of the invention. In FIG. 5A to FIG. 5C, the voltage levels of the center electrode are limited to four (from the center of the lens unit to the two sides of the lens unit) for illustrative purposes; however, people skilled in the pertinent art should be aware that the voltage levels of the center electrode are not limited to those shown in the drawings because the center electrode described herein may have plural center sub-electrodes.

With reference to FIG. SA which shows that a driver voltage is applied to the electrodes of the lens unit 200 depicted in FIG. 4. Here, the driver voltage applied to the electrodes of the lens unit 200 includes positive and negative voltages. Here, the driver voltage applied to the electrodes is, for instance, a DC driver voltage. Particularly, a voltage of the center electrode 122c of the electrode layer 222 is Vc, the voltage of the edge electrode 122e is Ve, the voltages of the main electrodes 122f and 222f are both Vf, the voltages of the first auxiliary electrodes 122m and 222m are both Vm, the voltages of the second auxiliary electrodes 122fm and 222fm are both Vfm, and the voltage of the electrode film 112 is Vtop (not shown). Here, Vf>Vc>Ve, Vf>Vtop>Ve, and Vf>Vm>Ve.

The threshold voltage of the anisotropic birefringence medium 230 is Vt (not shown), for instance, and the relationship between the threshold voltage Vt and the voltage Vtop of the electrode film 112 and the voltage Vc of the center electrode can be represented by |Vt|>|Vtop−Vc|. Besides, the relationship among the voltage Vf of the main electrode 222f, the voltage Vfm of the second auxiliary electrode 222fm, and the voltage Ve of the edge electrode 222e can be represented by Vf−Vfm>(Vf−Ve)/6.

Moreover, if the center electrode 122c includes the center sub-electrode 122c₀, the N right sub-electrodes 122cr₁ to 122crₙ, and the N left sub-electrodes 122cl₁ to 122clₙ, the N right sub-electrodes 122cr₁ to 122crₙ and the N left sub-electrodes 122cl₁ to 122clₙ are located on two sides of the center sub-electrode 122c₀, the voltage of the center sub-electrode 122c₀ is Vc, and a voltage of the N^{th} right sub-electrode and a voltage of the N^{th} left sub-electrode are Vn, respectively, the relationship among the voltage Vf of the main electrode 222f, the voltage Vfm of the second auxiliary electrode 222fm, and the voltages Vn of the sub-electrodes is Vc<Vn<Vfm<Vf.

With reference to FIG. 5B, the embodiment shown in FIG. 5B is similar to that shown in FIG. 5A, while the difference therebetween lines in that the driver voltage applied to the electrodes of the lens unit 200 is a positive voltage. Here, the driver voltage applied to the electrodes is, for instance, an AC driver voltage.

In the embodiment shown in FIG. 5B, each voltage is a positive voltage and is greater than zero, and the relationship among the voltages is the same as that provided in the embodiment shown in FIG. 5A. For instance, the voltages of the main electrodes 122f and 222f are Vf, the voltages of the first auxiliary electrodes 122m and 222m are Vm, the voltages of the second auxiliary electrodes 122fm and 222fm are Vfm, and the voltage of the electrode film 112 is Vtop. Here, Vf>Vc>Ve, Vf>Vtop>Ve, and Vf>Vm>Ve.

With reference to FIG. 5C, the embodiment shown in FIG. 5C is similar to that shown in FIG. 5A, while the difference therebetween lines in that the driver voltage applied to the electrodes of the lens unit 200 is a negative voltage. Here, the driver voltage applied to the electrodes is, for instance, an AC driver voltage.

In the embodiment shown in FIG. 5C, each voltage is a negative voltage and is less than zero, and the relationship among the voltages is the same as that provided in the embodiment shown in FIG. 5A. For instance, Vf>Vc>Ve, Vf>Vtop>Ve, and Vf>Vm>Ve.

According to an embodiment of the invention, at least two sets of side electrodes may be arranged in each lens unit; through the electric field distribution generated by the side electrodes, the electrode film, and other electrodes between the upper and lower substrates, the anisotropic birefringence medium may constitute a two-level Fresnel lens, such that the lens structure described herein can be flexibly applied in accordance with the size or the design of the display device.

To sum up, the anisotropic birefringence medium described in an embodiment of the invention may constitute an equivalent Fresnel lens through the design of the electrode pattern and voltages of the electrode film and the electrode layer as well as through the resultant electric field distribution. Particularly, the voltage of the second auxiliary electrode 122fm of the set of side electrodes and the voltage of the electrode film may be adopted to modify the shape of the oblique attack of the Fresnel lens, so as to change the tilting directions of the liquid crystal molecules and prevent the occurrence of disclination lines, crosstalk, and mura, thus improving the display quality of a stereo display device. Besides, plural sets of side electrodes may be arranged in each lens unit, such that the anisotropic birefringence medium described in an embodiment of the invention may constitute a multi-level Fresnel lens according to the design of the stereo display device.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A lens structure comprising a plurality of lens units, each of the lens units comprising:
an upper substrate and a lower substrate arranged opposite to each other;
an anisotropic birefringence medium located between the upper substrate and the lower substrate;
an electrode film located on the upper substrate, a voltage of the electrode film being Vtop;
a center electrode located on the lower substrate, a voltage of the center electrode being Vc;
an edge electrode located on the lower substrate and on two sides of the center electrode, a voltage of the edge electrode being Ve; and
at least one set of side electrodes located on the lower substrate and between the center electrode and the edge electrode, wherein each of the at least one set of side electrodes comprises a main electrode, a first auxiliary electrode, and a second auxiliary electrode, the first and second auxiliary electrodes are located on two sides of the main electrode, a voltage of the main electrode is Vf, a voltage of the first auxiliary electrode is Vm, and a voltage of the second auxiliary electrode is Vfm,
wherein
Vf>Vc>Ve,
Vf>Vtop>Ve, and
Vf>Vm>Ve,
such that an electric field distribution is generated between the upper substrate and the lower substrate, and the electric field distribution allows the anisotropic birefringence medium to constitute a Fresnel lens.

2. The lens structure as recited in claim 1, wherein a threshold voltage of the anisotropic birefringence medium is Vt, and

|Vt|>|Vtop−Vc|.

3. The lens structure as recited in claim 1, wherein
Vf−Vfm>(Vf−Ve)/6.

4. The lens structure as recited in claim 1, wherein the main electrode of each of the at least one set of side electrodes is located between the first auxiliary electrode and the second auxiliary electrode, the first auxiliary electrode is located between the main electrode and the edge electrode, and the second auxiliary electrode is located between the main electrode and the center electrode.

5. The lens structure as recited in claim 1, wherein a slit is between the main electrode and the second auxiliary electrode of each of the at least one set of side electrodes, a width of the slit is D, a pitch of each of the lens units is P, and D/P≦5%.

6. The lens structure as recited in claim 1, wherein the second auxiliary electrode of each of the at least one set of side electrodes has a width W, a pitch of each of the lens units is P, and W/P≦5%.

7. The lens structure as recited in claim 1, wherein the center electrode comprises a center sub-electrode, N right sub-electrodes, and N left sub-electrodes, and the N right sub-electrodes and the N left sub-electrodes are located on two sides of the center sub-electrode.

8. The lens structure as recited in claim 7, wherein a voltage of the center sub-electrode is Vc, a voltage of an N^{th} right sub-electrode of the N right sub-electrodes and a voltage of an N^{th} left sub-electrode of the N left sub-electrodes are Vn, respectively, and Vc<V1<Vn−1<Vn.

9. The lens structure as recited in claim 7, wherein
Vc<Vn<Vfm<Vf.

10. The lens structure as recited in claim 1, wherein
the edge electrode comprises a right edge electrode and a left edge electrode, the right edge electrode and the left edge electrode being correspondingly arranged on two sides of the center electrode; and
the at least one set of side electrodes comprises at least one set of right side electrodes and at least one set of left side electrodes, the at least one set of right side electrodes being arranged between the center electrode and the right edge electrode, the at least one set of left side electrodes being arranged between the center electrode and the left edge electrode.

11. The lens structure as recited in claim 10, wherein
each of the at least one set of right side electrodes comprises a right main electrode, a first right auxiliary electrode, and a second right auxiliary electrode, the first right auxiliary electrode and the second right auxiliary electrode being located on two sides of the right main electrode; and
each of the at least one set of left side electrodes comprises a left main electrode, a first left auxiliary electrode, and a second left auxiliary electrode, the first left auxiliary electrode and the second left auxiliary electrode being located on two sides of the left main electrode.

12. The lens structure as recited in claim 10, wherein the right edge electrode and the left edge electrode are mirror-symmetrical to each other, and the at least one set of right side electrodes and the at least one set of left side electrodes are mirror-symmetrical to each other.
